(19) United States
(12) Patent Application Publication
(10) Pub. No.: US 2015/0123391 A1
(43) Pub. Date: May 7, 2015

(54) STEERING CORRECTION AND SUPPORT DEVICE AND METHODS OF MAKING AND USING SAME

(71) Applicant: ReadyLIFT Suspension, Inc., Henderson, NV (US)

(72) Inventors: Jeffery Allen Yoder, El Cajon, CA (US); Scott Evan Poncher, Henderson, NV (US)

(21) Appl. No.: 14/531,073

(22) Filed: Nov. 3, 2014

Related U.S. Application Data
(60) Provisional application No. 61/899,752, filed on Nov. 4, 2013.

(51) Int. Cl. B62D 1/20; F16D 3/26

(52) U.S. Cl. CPC B62D 1/20; F16D 3/26
USPC 280/780; 29/402.03

(57) ABSTRACT

A device for correcting a length and an angle of a steering shaft in a rack and pinion steering system of a vehicle after a distance between a steering wheel and a rack is altered comprises a coupler having a straight portion and an angular portion. The straight portion has a proximal end and a distal end, and the straight portion is coupled at the proximal end to the angular portion with a universal joint that allows for angular movement of the angular portion with respect to the straight portion. The device comprises an extension shaft that is coupled to the straight portion at the distal end, and a locking member having a threaded shaft and a casing having an opening. The opening is configured to receive the extension shaft. Each of the extension shaft and the angular portion are configured to be operably coupled to the steering shaft.

### CROSS-REFERENCE TO RELATED APPLICATIONS

This application claims priority to U.S. Provisional Patent Application Ser. No. 61/899,752 filed Nov. 4, 2013, the disclosure of which is incorporated herein by reference in its entirety.

### FIELD OF THE INVENTION

The invention relates generally to the field of vehicular steering systems. More specifically, the invention relates to a device for supporting steering shaft extensions in rack and pinion style steering systems.

### SUMMARY

Systems and methods for correcting a length and an angle of a steering shaft in a rack and pinion type steering system are disclosed herein. According to an embodiment, a device for correcting a length and an angle of a steering shaft in a rack and pinion steering system of a vehicle after a distance between a steering wheel and a rack is altered comprises a coupler having a straight portion and an angular portion. The straight portion has a proximal end and a distal end. The straight portion is coupled at the proximal end to the angular portion with a universal joint. The universal joint allows for angular movement of the angular portion with respect to the straight portion. The device includes an extension shaft. The extension shaft is coupled to the straight portion at the distal end. The device also includes a locking member comprising a threaded shaft and a casing. The casing has a ball swivel with an opening. The opening is configured to receive the extension shaft. A retaining member of the device is configured to receive the threaded shaft. The retaining member has a first cylinder and a second cylinder adjacent the first cylinder. A diameter of the first cylinder is greater than a diameter of the second cylinder. The first cylinder has a passageway to receive a pinch bolt. The device has a clip configured to be secured to a frame of the vehicle. The second cylinder is configured to be passed through a surface of the clip such that the first cylinder abuts the surface. Each of the extension shaft and the angular portion are configured to be operably coupled to the steering shaft.

According to another embodiment, a method for correcting a length and an angle of a steering shaft in a rack and pinion steering system of a vehicle after a vertical distance between a steering wheel and a rack is altered comprises the step of dividing the steering shaft into a first portion and a second portion. A steering correction device is provided. The device comprises a coupler having a straight portion and an angular portion. The straight portion has a proximal end and a distal end, and the straight portion is coupled at the proximal end to the angular portion with a universal joint. The device further comprises an extension shaft that is coupled to the straight portion at the distal end, and a locking member having a threaded shaft and a casing having an opening. The method includes the step of passing the extension shaft through the opening such that the casing is adjacent the straight portion, and the step of coupling the first portion to the angular portion. The second portion is coupled to the extension shaft, and the threaded shaft is operably secured to a frame of the vehicle.

According to yet another embodiment, a method for correcting a length and an angle of a steering shaft in a rack and pinion steering system of a vehicle after a vertical distance between a steering wheel and a rack is altered includes the step of providing a steering correction device. The steering shaft has a first segment and a second segment. The first segment has a first end and a second end, and the second segment has a third end and a fourth end. The first end is operably coupled to the steering wheel, and the fourth end is operably coupled to a pinion gear. The second end is coupled to the third end via a first universal joint. The device has a coupler having a straight portion and an angular portion. The straight portion has a proximal end and a distal end. The straight portion is coupled at the proximal end to the angular portion with a second universal joint. The device includes an extension shaft that is coupled to the straight portion at the distal end, and a locking member having a threaded shaft and a casing with an opening. The method includes the steps of decoupling the fourth end from the pinion gear, and passing the extension shaft through the opening such that the casing is adjacent the straight portion. The extension shaft is operably coupled to the fourth end, and the angular portion is operably coupled to the pinion gear. The threaded shaft is operably secured to a frame of the vehicle.

### BRIEF DESCRIPTION OF THE SEVERAL VIEWS OF THE DRAWINGS

Illustrative embodiments of the present invention are described in detail below with reference to the attached drawing figures and wherein:

FIG. 1 is a perspective view of a PRIOR ART rack and pinion steering system for a vehicle;

FIGS. 2A-2C are graphical representations of angles and distances between a rack and a steering wheel of the vehicle;

FIG. 3 is a perspective view of the rack of pinion steering system of FIG. 1 after a steering correction and support device is secured thereto, according to an embodiment of the current invention;

FIG. 4 is a perspective view of the steering correction and support device of FIG. 3;

FIG. 5 is a perspective view of a locking member of the steering correction and support device of FIG. 3;

FIG. 6 is another perspective view of the steering correction and support device of FIG. 3;

FIG. 7 is a perspective view of the steering correction and support device of FIG. 3 but secured to a drop bracket:

FIG. 8 is a flow chart illustrating a method of using the steering correction and support device of FIG. 3, according to an embodiment;

FIG. 9 is a perspective view of another PRIOR ART rack and pinion steering system for a vehicle; and

FIG. 10 is a perspective view of the rack and pinion steering system of FIG. 9 after the steering correction and support device of FIG. 3 is secured thereto, according to an embodiment.

### DETAILED DESCRIPTION

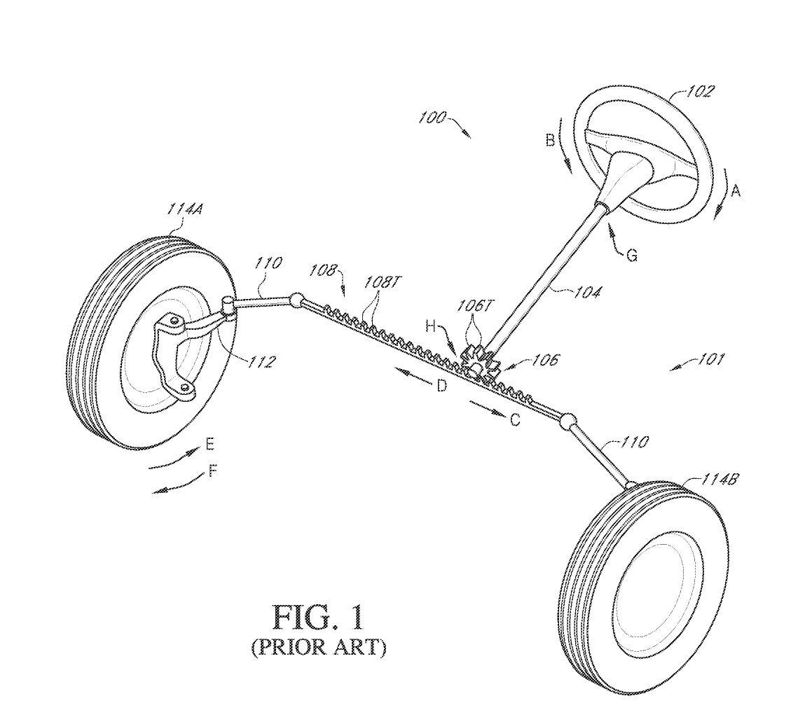

Embodiments of the present invention provide systems and methods for ensuring that rack and pinion style steering systems function as originally intended although a vertical distance between the rack and the steering wheel is altered. FIG. 1 shows a conventional rack and pinion style steering system 100 for a vehicle 101, as is known in the art. The rack and pinion steering system 100 may include a steering wheel 102, a steering shaft 104, a pinion gear 106, a rack 108, tie rods 110, steering arms 112, and front wheels 114A and 114B.

The steering wheel 102 may be rotatable about its axis in a direction A or a direction B. Rotation of the steering wheel 102 in the direction A may cause the front wheels 114A, 114B to collectively turn in direction E, whereas rotation of the steering wheel 102 in the direction B may cause the front wheels 114A, 114B to collectively turn in direction F. In rack and pinion style steering systems, such as the system 100, this works in practice as follows. The steering wheel 102 may be operably coupled to the steering shaft 104, and the steering shaft 104 may in-turn be operably coupled to the pinion gear 106. The pinion gear 106 may have teeth 106T, and the rack 108 may have teeth 108T that mesh with the teeth 106T of the pinion gear 106. As the steering wheel 102 is rotated, e.g., in the direction A, it causes the steering shaft 104 to rotate in the direction A, which causes the pinion gear 106 to also rotate in the direction A. As the teeth 106T of the pinion gear 106 are in mesh with the teeth 108T of the rack 108, rotation of the pinion gear 106 in the direction A causes the rack 108 to move laterally in direction D. This lateral movement of the rack 108 causes the tie rods 110 and the steering arms 112 to also move, which movement in-turn causes the front wheels 114A, 114B to collectively turn in direction E (e.g., to turn the vehicle 101 to the left). Similarly, when the steering wheel 102 is rotated in the direction B, the steering shaft 104 and the pinion gear 106 also rotate in the direction B. The rotation of the pinion gear 106 in the direction B causes the rack 108 to move laterally in the direction C, which causes the tie-rods 110 and the steering arms 112 to move and turn the front wheels 114A, 114B collectively in direction F (e.g., to turn the vehicle 101 to the right).

As can be appreciated from FIG. 1, the steering wheel 102 may not be centered between the front wheels 114A, 114B. For example, in the United States, the steering wheel 102 of the vehicle 101 may be located towards the vehicle's left hand side for access by a driver sitting in the driver's seat (i.e., the steering wheel 102 may be closer to the driver side wheel 114B as compared to the passenger side wheel 114A). The steering shaft 104 associated with the steering wheel 102, and the pinion gear 106 that is coupled to the shaft 104, may similarly be located on that side.

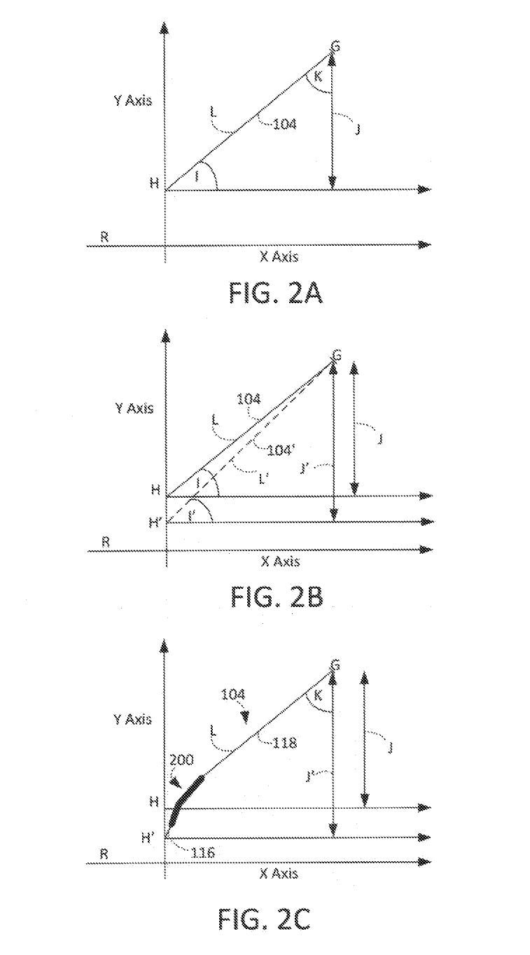

The steering wheel 102 may be located in the interior cabin of the vehicle 101 so that it is accessible to the driver, whereas the rack 108 may be located proximate the front wheels 114A, 114B. As such, a vertical distance between a road R (or other such surface) and the steering wheel 102 may be greater than a vertical distance between the rack 108 and the road R. Thus, as can be seen in FIG. 1, the steering shaft 104 that couples the steering wheel 102 to the pinion gear 106 may extend from the pinion gear 106 at an angle from the horizontal. Assume for the purposes of illustration that the steering shaft 104 is operably coupled to the steering wheel 102 at a point G and that the pinion gear 106 interacts with the rack 108 at a point H. FIG. 2A shows these points G and H in a two-dimensional plane. As can be seen, the steering shaft 104, which has a length L, extends from the horizontal plane at angle I, and in the vertical plane, is at a distance J from the rack 108.

The rack 108 may be fixed to the frame of the vehicle 101 such that the vertical distance J between the rack 108 and the steering wheel 102 remains generally constant, particularly where the vehicle 101 is at rest. In certain situations, e.g., when the ride height of the vehicle 101 is altered (i.e., raised or lowered), it may be desirable to permanently reposition the rack 108 with respect to the steering wheel 102. Such a repositioning of the rack 108, however, may disrupt the alignment of the pinion gear 106 with the rack 108, which may in-turn undesirably impact the steering response of the vehicle 101 and cause accelerated wear of the components of the suspension and the rack and pinion steering system 100 of the vehicle 101. On the other hand, if the vertical distance between J between the rack 108 and the steering wheel 102 changes and the rack 108 is not relocated, the rack and pinion steering system 100 may bind and/or fail, and the steering and suspension components may wear prematurely, which too is undesirable.

Assume, for example, as shown in FIG. 2B, that the ride height of the vehicle 101 is changed such that the pinion gear 106 interacts with the rack 108 at a point H′ which in the vertical plane is closer to the road R than the point H. As can be appreciated, a steering shaft 104′ that extends between the points G and H′ may not only have a different length L′ (which, in this example, may be greater than the length L of the steering shaft 104), but may also extend from the horizontal plane at a different angle I′ (which, in this example, may also be greater than the angle I). It will thus be appreciated that if the vertical distance J between the rack 108 and the steering wheel 102 is changed, it may be insufficient to simply alter the length L of the steering shaft 104; rather, to ensure that the rack 108 properly interacts with the pinion gear 106, the angle I of the shaft 104 with the horizontal plane may also need to be altered. This is true regardless of whether point G is raised or lowered, or point H is raised or lowered.

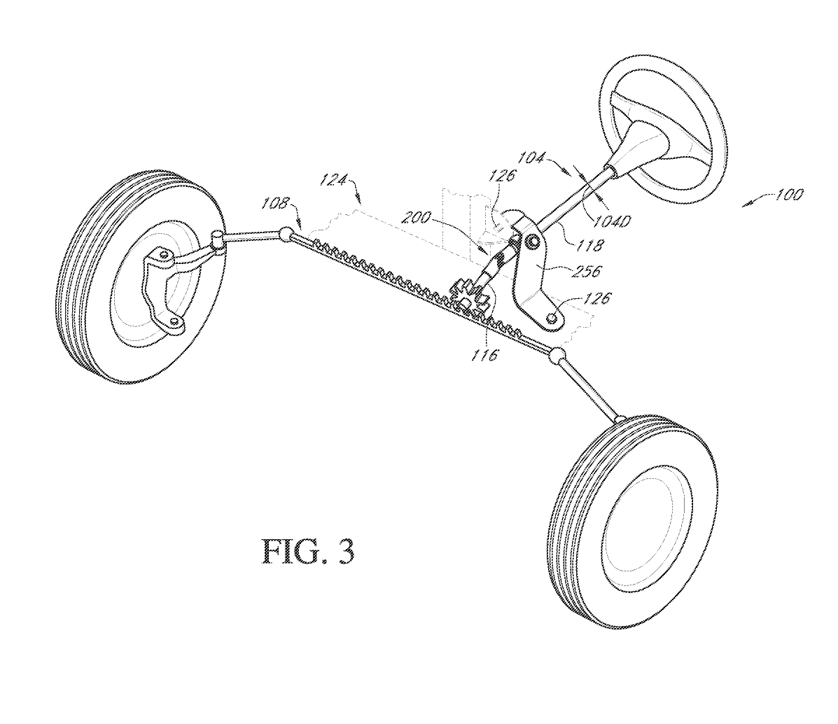

Attention is directed now to FIG. 3, which shows a steering correction and support device 200 in line with the teachings of the current invention. The steering correction and support device 200 may allow for proper alignment of the pinion gear 106 and the steering shaft 104 with the rack 108 notwithstanding a change in the vertical distance J between the rack 108 and the steering wheel 102. While FIG. 2B shows that the vertical distance J between the rack 108 and the steering wheel 102 changes when the rack 108 is repositioned such that it is closer to the road R, those skilled in the art will appreciate that the vertical distance J between the steering wheel 102 and the rack 108 may change for other reasons (e.g., when the rack 108 is repositioned such that it is further away from the road R, when the vehicle cabin is raised relative to the road R, et cetera) and that the device 200 may adequately ensure the proper functionality of the rack and pinion steering system 100 (i.e., account for the change in the length L and the angle I of the steering shaft 104) any time the vertical distance J between the rack 108 and the steering wheel 102 is increased or decreased.

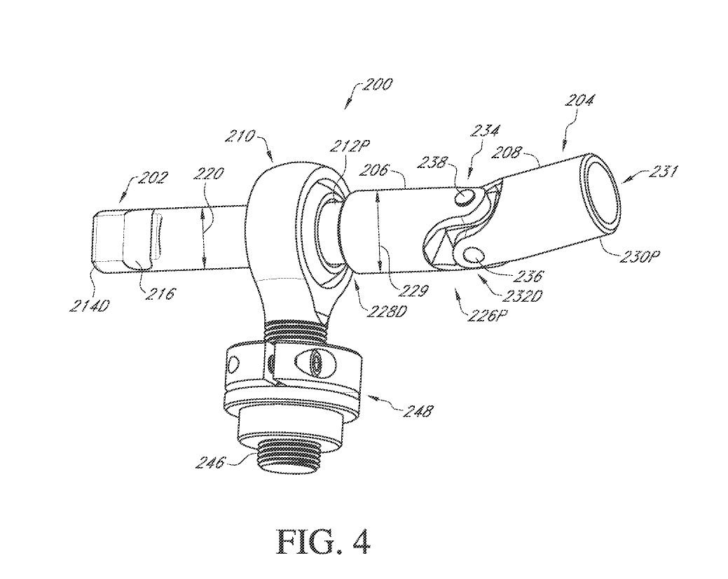

FIG. 4 shows the steering correction and support device 200 in additional detail. As can be seen, the device 200 may have an extension shaft 202, a coupler 204 having a straight portion 206 and an angular portion 208, and a locking member 210.

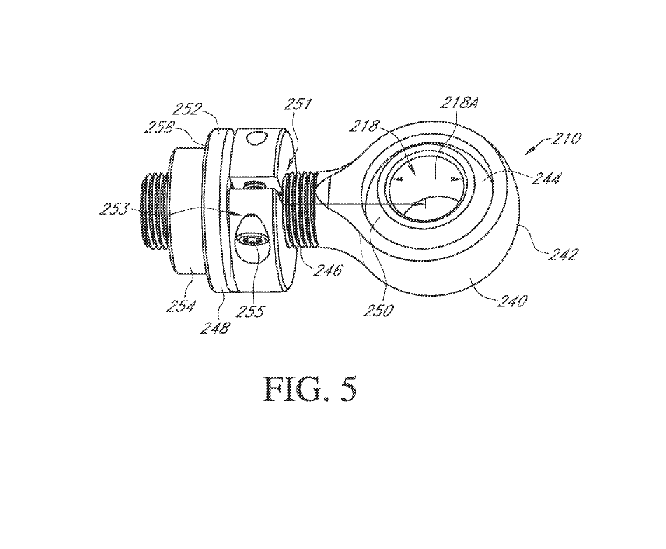

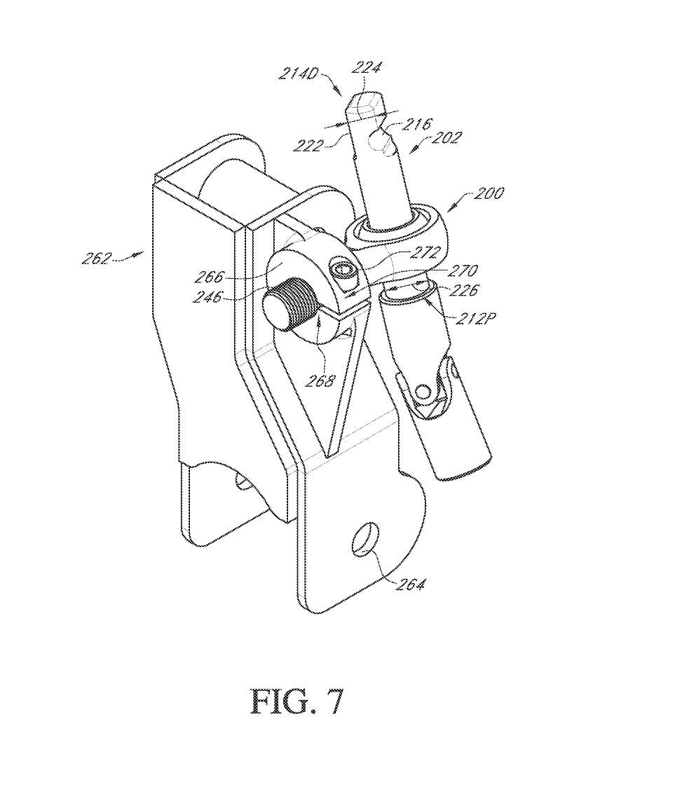

The extension shaft 202 may have a proximal end 212P and a distal end 214D. While not required, a notch or groove 216 may be provided adjacent the distal end 214D. The extension shaft 202 may extend through an opening 218 having a height 218A (see FIG. 5) in the locking member 210. The extension shaft 202 may in some embodiments be generally cylindrical, and a diameter 220 of the shaft 202 may be configured to be less than a diameter 104D of the steering shaft 104. Further, in some embodiments, the extension shaft 202 may have a flat portion 222 adjacent the distal end 214D (see FIG. 7) and opposite the notch 216, and a height 224 of the shaft 202 at the distal end 214D may be less than a height 226 of the shaft 202 at the proximal end 212P. The notch 216 and the flat portion 222 may facilitate the coupling of the extension shaft 202 at its distal end 214D to the steering shaft 104, as discussed in more detail below.

At the proximal end 212P, the extension shaft 202 may be coupled to the straight portion 206 of the coupler 204. Specifically, the straight portion 206 may have a proximal end 226P and a distal end 228D, and the extension shaft 202 and the straight portion 206 may be coupled such that the proximal end 212P of the extension shaft 202 is adjacent the distal end 228D of the straight portion 206. This coupling may be effectuated in any desirable manner. For example, the straight portion 206 may be welded to the extension shaft 202, machined with the extension shaft 202 as a single unit, bolted to the extension shaft 202 via fasteners or rivets, et cetera. In some embodiments, the distal end 228D of the straight portion 206 of the coupler 204 may have a female attachment that fits over and encompasses the proximal end 212P of the extension shaft 202; for example, the extension shaft 202 may have external threading (not shown) at its proximal end 212P and the straight portion 206 may have internal threading at its distal end 228D that correspond thereto. While not required, the straight portion 206 may be generally cylindrical. A height 229 of the straight portion 206, at least at its distal end 228D, may be greater than the height 218A of the opening 218 of the locking member 210 (see FIG. 5), which may ensure that the straight portion 206 does not pass through the opening 218 of the locking member 210.

The angular portion 208 of the coupler 204 may be operably coupled to the straight portion 206 at its proximal end 226P. Specifically, the angular portion 208 may have a proximal end 230P and a distal end 232D, and the straight portion 206 may be coupled at its proximal end 226P to the distal end 232D of the angular portion 208 via a universal joint 234. The universal joint 234 may be formed by a pair of opposing hinges 236 at the distal end 232D of the angular portion 208 and a pair of opposing hinges 238 at the proximal end 226P of the straight portion 206. The pair of hinges 236 may be oriented at 90 degrees from the pair of hinges 238, and the hinges 236, 238 may be connected to each other via a cross-shaft (not clearly shown). The universal joint 234 may allow for the angular movement of the angular portion 208 with respect to the straight portion 206 is any direction (i.e., in the x, y, and z planes). The proximal end 230P of the angular portion 208 may comprise a female attachment (e.g., a socket) 231 to allow the angular portion 208 to be coupled to the steering shaft 104, as discussed below. The socket 231 may in some embodiments be formed integrally with the angular portion 208.

Attention is directed now to FIG. 5, which shows the locking member 210. The locking member 210 may comprise a spherical rod end bearing (also known in the art as a Heim or rose joint) 240 and a retaining member 248. The spherical rod end bearing 240 may have a casing 242, a ball swivel 244 having the opening 218, and a threaded shaft 246. The ball swivel 244 may be configured to have little or no play, and the ball swivel 244 may remain generally stationery after the device 200 has been secured to the steering shaft 104 as discussed below.

While not required, the retaining member 248 may comprise two concentric cylinders, i.e., a first cylinder 252 and a second cylinder 254, and a diameter of the second cylinder 254 may be less than that of the first cylinder 252. The threading of the threaded shaft 246 may be configured to correspond to internal threading 251 (not clearly visible) of the first cylinder 252 and/or the second cylinder 254 of the retaining member 248. A distance 250 from the center of the opening 218 to the top of the retaining member 248 may be varied in line with the requirements of the particular application using the corresponding threading of the threaded shaft 246 and the retaining member 248. In some embodiments, instead of or in addition to the internal threading 251, the first cylinder 252 may have an internally threaded passageway 253 configured to accept and retain a pinch bolt 255. The pinch bolt 255 may be secured to the first cylinder 252 after the distance 250 has been set in line with the requirements of the particular application, and may prevent further rotation or other movement of the threaded shaft 246.

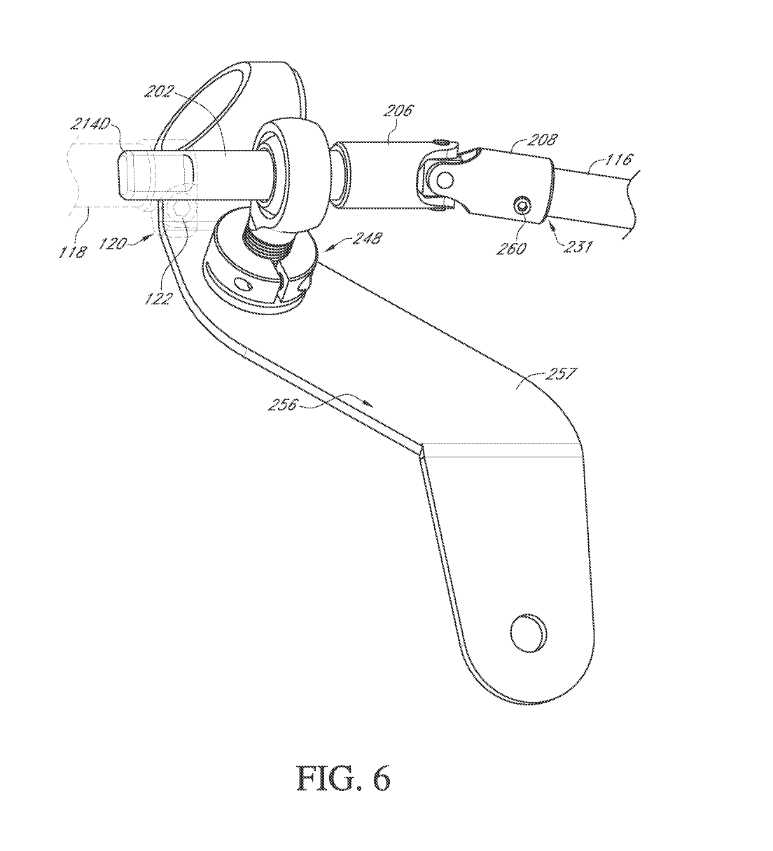

The retaining member 248 may be secured to a clip 256 (see FIG. 6). This securement may be effectuated in any desirable manner; for example, the retaining member 248 may be welded to the clip 256, secured thereto via fasteners or adhesives, et cetera. In one embodiment, the second cylinder 254 may be passed through a surface 257 of the clip 256, and a lower surface 258 of the first cylinder 252 (see FIG. 5) may abut against the clip surface 257 (i.e., act as a stop) and prevent the first cylinder 252 from passing through the clip surface 257.

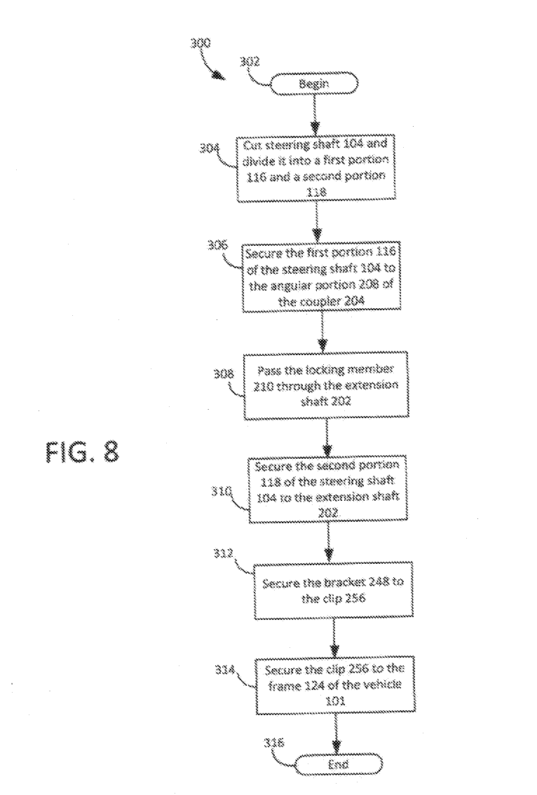

As discussed above, an alteration of the vertical distance J between the rack 108 and the steering wheel 102 from the factory specifications may cause the pinion gear 106 to be undesirably misaligned with the rack 108. Attention is now directed to FIG. 8 (and to FIGS. 3 and 6) which illustrates a method 300 of using the device 200 to ensure the continued viability of the rack and pinion steering system 100 after the vertical distance J between the rack 108 and the steering wheel 102 is altered.

The method 300 may begin at step 302, and at step 304, a user may cut the steering shaft 104 and divide it into a first portion 116 and a second portion 118 (see FIG. 3). While not required, it may be desirable in some applications to cut the steering shaft 104 such that the length of the second portion 118 of the shaft 104 is substantially greater than the length of the first portion 116. At step 306, the user may secure the first portion 116 of the steering shaft 104 to the angular portion 208 of the coupler 204 via the socket 231 (see FIG. 4). For example, as shown in FIG. 6, the first portion 116 of the steering shaft 104 (and specifically, that end of the first portion 116 that is not coupled to the pinion gear 106 or a pinion input shaft) may be inserted into the socket 231 of the angular portion 208 and secured in place using fasteners 260. Of course, the first portion 116 of the steering shaft 104 may also be secured to the angular portion 208 of the device 200 using other means, such as via adhesives, welding, rivets, et cetera.

At step 308, the locking member 210 may be passed through the extension shaft 202 (i.e., the opening 218 in the ball swivel 244 of the locking member 210 may be passed through the extension shaft 202 at its distal end 214D) such that the casing 242 of the locking member 210 is adjacent the distal end 228D of the straight portion 206 of the coupler 204. At step 310, the second portion 118 of the steering shaft 104 (and specifically, that end of the second portion 118 that is not coupled to the steering wheel 102) may be secured to the extension shaft 202 (i.e., at its distal end 214D) of the device 200. The second portion 118 of the steering shaft 104 may be secured to the extension shaft 202 in any desirable manner. For example, as shown in FIG. 6, the distal end 214D of the extension shaft 202 may be passed through the second portion 118 of the steering shaft 104 and secured thereto using a clasp 120 and a fastener 122. The notch 216 and the flat surface 222 of the extension shaft 202 may facilitate such securement. Of course, the second portion 118 may be secured to the extension shaft 202 by other means, such as with welding, adhesives, attachments having corresponding threading, et cetera.

At step 312, the retaining member 248 may be secured to the clip 256. For example, as discussed above, the second cylinder 254 of the retaining member 248 may be passed through the surface 257 of the clip 256 and welded to the underside of the clip 256. The distance 250 (see FIG. 5) from the center of the opening 218 to the top of the retaining member 248 may be adjusted in line with the requirements of the particular application (using, e.g., the corresponding threading of the threaded shaft 246 and the retaining member 248 and/or the pinch bolt 255) prior to securing the retaining member 248 to the clip 256, or thereafter.

At step 314, the clip 256 may be secured to a frame 124 (or chassis, drive train, suspension, et cetera) of the vehicle 101 (see FIG. 3). For example, the clip 256 may be secured to the vehicle frame 124 using fasteners 126, or other desirable means. Once the clip 256 is secured to the frame 124, the steering shaft 104 and the device 200 may be unable to move from side to side or front to back. However, the dimensions of the opening 218 in the locking member 210 may be configured such that the rotation of the device 200 and the steering shaft 104 (upon the rotation of the steering wheel 102) remains unencumbered. The method 300 may end at step 316.

The various dimensions of the device 200 may be varied as desired in line with the requirements of the particular application. It will be appreciated that the various steps of the method 300 need not be performed in the order described. For example, the device 200 may be secured to the second portion 118 of the steering shaft 104 prior to being secured to its first portion 116, the clip 256 may be secured to the retaining member 248 after the clip 256 has been secured to the frame 124 of the vehicle 101, et cetera.

Thus, as will be appreciated, the steering correction and support device 200 may allow for the continued functionality and viability of the rack and pinion steering system 100 after the vertical distance J between the steering wheel 102 and the rack 108 is adjusted. Specifically, as discussed above, when the vertical distance J between the steering wheel 102 and the rack 108 is adjusted, both the length L and the angle I of the steering shaft 104 with the horizontal may need to be altered. The extension shaft 202 of the device 202 may account for the required change in the length L, and the angular portion 204 may account for the required change in the angle I.

Attention is directed back to FIG. 2A. The steering shaft 104 (and more specifically, the second portion 118 of the steering shaft 104, (see FIG. 3)) may extend from the steering wheel 102 at an angle K with the vertical. Often, it is undesirable or unfeasible to alter this angle K (e.g., because the steering shaft 104 is operably coupled to the steering wheel 102 at the point G permanently, because the point G is not easily accessible, et cetera). As will be appreciated from the disclosure herein, and as illustrated in FIG. 2C, the device 200 may be properly secured to the steering shaft 104 and allow for the continued functionality of the rack and pinion steering system 100 after the vertical distance J between the steering wheel 102 and the rack 108 is adjusted (e.g., to J′) without the need to alter the angle K.

While the disclosure above generally describes a situation where the vertical distance J between the steering wheel 102 and the rack 108 is increased (i.e., a situation that necessitates that the length L of the steering shaft 104 be increased), the device 202 may also be used when the vertical distance J between the rack 108 and the steering wheel 102 is decreased (i.e., a situation that necessitates that the length L of the steering shaft 104 be decreased). Specifically, when the vertical distance J between the steering wheel 102 and the rack 108 is decreased, instead of only dividing the steering shaft 104 into two portions 116 and 118, a portion of the steering shaft 104 may also be removed so that the effective length L′ of the steering shaft 104, after the device 200 is secured thereto, is less than its original length L. Moreover, it will be appreciated that the device 200 may also be used to ensure the continued functionality of the rack and pinion steering system 100 when the distance between the rack 108 and the steering wheel 102 in the horizontal plane (either by itself or along with the vertical distance J between the steering wheel 102 and the rack 108) is altered from its factory specifications.

It may be desirable to secure the device 200 to the frame 124 of the vehicle 101 such that the device 200 is in close proximity to the rack 108. As discussed above, the clip 256 may be used to secure the device 200 to the frame 124. The use of the clip 256, however, is not a requirement, and the device 200 may be secured to the frame 124 via other means. For example, FIG. 7 shows a drop bracket 262 that may alternatively be used to secure the device 200 to the frame 124. The drop bracket 262 may have holes 264 that allow the drop bracket 262 to be secured to the frame 124 using fasteners (not shown), and a threaded bung 266. The threaded bung 266 may have internal threading 268 (not clearly visible) that correspond to the external threading of the threaded shaft 246 of the locking member 210. As will be appreciated, the drop bracket 262 may eliminate the need for the retaining member 248 that was used to secure the device 200 to the clip 256. In some embodiments, instead of or in addition to the internal threading 268, the threaded bung 262 may have a threaded passageway 270 configured to accept and retain a pinch bolt 272. The pinch bolt 272, once secured, may prevent further rotation or other movement of the threaded shaft 246.

People of skill in the art will appreciate that while the disclosure above discusses the securement of the device 200 to the shaft 104 after the shaft 104 is divided into the first and second portions 116, 118, that dividing the shaft 104 in this manner is not a prerequisite to the proper utilization of the device 200. Specifically, in some embodiments, instead of dividing the steering shaft 104 into the first and second portions 116, 118, the steering shaft 104 may be decoupled from the pinion gear 106 (e.g., from an input shaft of the pinion gear 106), and the device 200 may be secured to the steering shaft 104 and the pinion gear 106 (i.e., the extension shaft 202 may be secured to the decoupled end of the steering shaft 104 and the angular portion 204 may be coupled to the pinion gear 106).

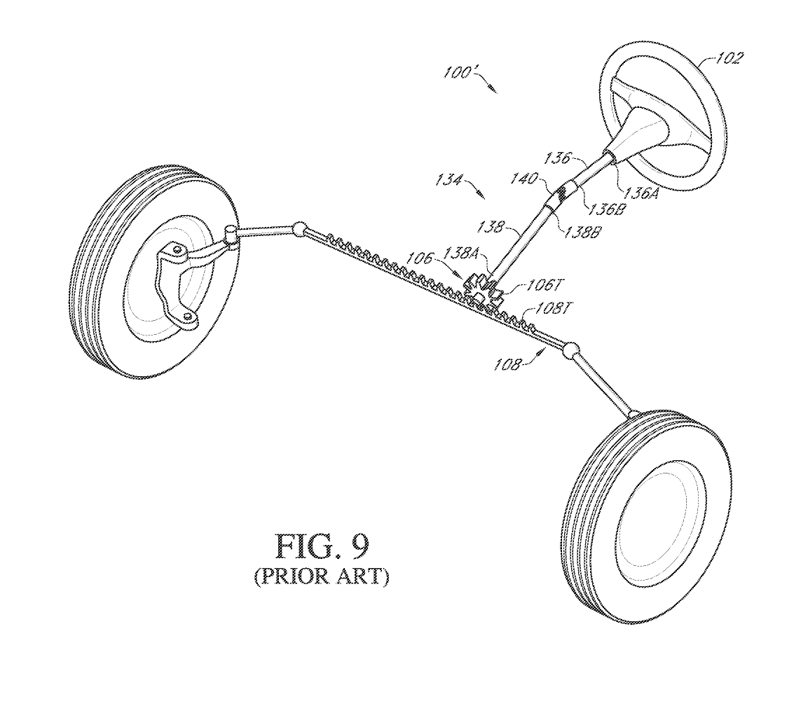

Attention is directed now to FIG. 9, which illustrates an alternate version 100′ of the stock rack and pinion steering system 100 of FIG. 1. The prior art rack and pinion steering system 100′ is substantially similar to the rack and pinion steering system 100, except as specifically noted and/or shown, or as would be inherent. For uniformity and brevity, corresponding reference numbers may be used to indicate corresponding parts, though with any noted deviations.

The main difference between the rack and pinion steering system 100 and the rack and pinion steering system 100′ is that the latter, instead of having the steering shaft 104, has a steering shaft 134. As can be seen, the steering shaft 134 has a first segment 136 having ends 136A, 136B, and a second segment 138 having ends 138A, 138B. The end 136A of the first segment 136 of the steering shaft 134 is operably coupled to the steering wheel 102, whereas the end 138A of the second segment 138 of the steering shaft 134 is operably coupled to the pinion gear 106. The ends 136B, 138B, of the first and second segments 136, 138 of the shaft 134, respectively, are each coupled to a stock universal joint 140. The stock universal joint 140 may be provided by the manufacturer of the rack and pinion steering system 100′ to, for example, conveniently situate the steering wheel 102 on one side (e.g., on the left hand side in the U.S. for access by a driver sitting in the driver's seat) of the vehicle 101 while ensuring that the shaft 134 properly interacts with the pinion 106 and the rack 108.

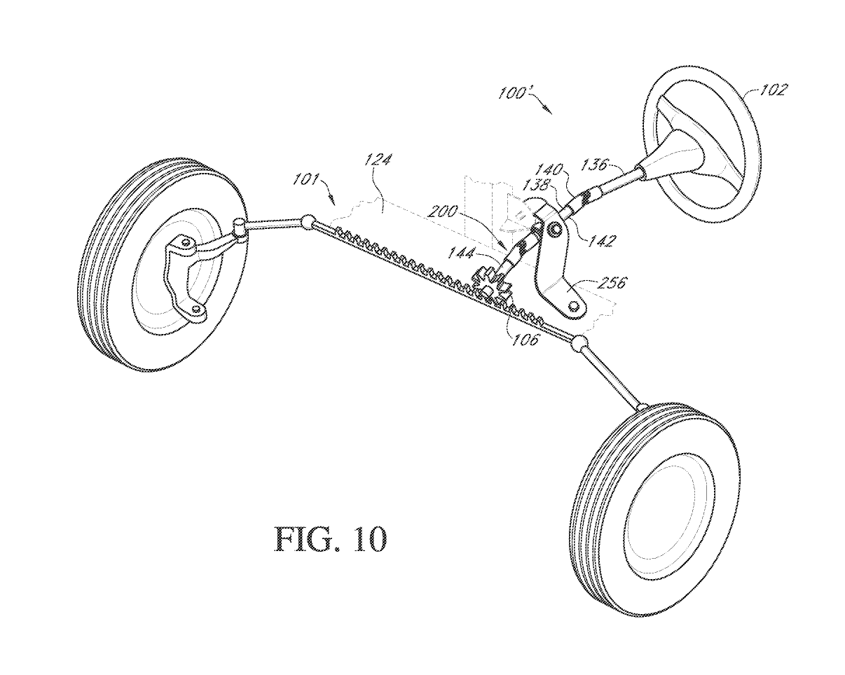

The device 200 (which, as discussed above, may ensure the continued viability of the rack and pinion steering system 100 notwithstanding a change in the vertical distance J between the rack 108 and the steering wheel 102) may allow for the rack and pinion steering system 100′ to function as intended after the vertical distance J between the rack 108 and the steering wheel 102 is altered. Specifically, as shown in FIG. 10, to use the device 200 with the rack and pinion steering system 100′, the second segment 138 of the steering shaft 134 may be divided into a first part 142 and a second part 144 (i.e., a first part 142 that extends from the stock universal joint 140 and a second part 144 that extends from the pinion gear 106), and the device 200 may be secured to each of the first and second parts 142, 144, respectively. More specifically, to properly utilize the device 200 with the rack and pinion steering system 100′ according to an embodiment, the following steps may be performed: (a) the second segment 138 of the steering shaft 134 may be divided into the first and second parts 142, 144, respectively; (b) the angular portion 204 (see FIG. 4) of the device 200 may be secured to the second segment 144 (i.e., that end of the second segment 144 that is not operably coupled to the pinion gear 106); (c) the locking member 210 (see FIG. 4) of the device 200 may be passed through the extension shaft 202 such that the casing 242 of the locking member 210 is adjacent the distal end 228D of the straight portion 206 of the coupler 204; (d) the extension shaft 202 of the device 200 may be secured to the first segment 142 (i.e., that end of the first segment 142 that is not operably coupled to the stock universal joint 140); (e) the bracket 248 (see FIG. 6) may be secured to the clip 256; and (f) the clip 256 may in-turn be secured to the frame 124 of the vehicle 101.

It will be appreciated that when using the device 200 in this manner, the angle that the first segment 136 makes with the vertical is not undesirably altered. Further, as discussed above with respect to the rack and pinion steering system 100, people of skill in the art will appreciate that dividing the second segment 138 of the shaft 134 of the system 100′ is not a prerequisite to the proper utilization of the device 200. For example, in some embodiments, instead of dividing the second segment 138 into the first and second parts 142, 144, the end 138A of the second segment may be decoupled from the pinion gear 106 (e.g., from an input shaft of the pinion gear 106), and the device 200 may be secured to the second segment 138 and the pinion gear 106 (i.e., the extension shaft 202 may be secured to the decoupled end 138A of the second segment 138, and the angular portion 204 may be coupled to the pinion gear 106).

Thus, as has been described, the steering correction and support device 200 may allow for the continued functionality and viability of different types of rack and pinion steering systems (e.g., the rack and pinion steering systems 100 and 100′) after the vertical distance J between the steering wheel 102 and the rack 108 is adjusted. People of skill in the art will readily appreciate that while simplistic mechanical models of rack and pinion steering systems are disclosed herein so that the workings of the device 200 are not needlessly obfuscated, that the device 200 can function equally well with state of the art rack and pinion steering systems (e.g., rack and pinion steering system incorporating modern electronics and/or hydraulics).

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. A device for correcting a length and an angle of a steering shaft in a rack and pinion steering system of a vehicle after a distance between a steering wheel and a rack is altered, the device comprising:
a coupler having a straight portion and an angular portion; the straight portion having a proximal end and a distal end; the straight portion being coupled at the proximal end to the angular portion with a universal joint; the universal joint allowing for angular movement of the angular portion with respect to the straight portion;
an extension shaft; the extension shaft being coupled to the straight portion at the distal end;
a locking member comprising a threaded shaft and a casing; the casing having a ball swivel with an opening; the opening being configured to receive the extension shaft;
a retaining member for receiving the threaded shaft; the retaining member having a first cylinder and a second cylinder adjacent the first cylinder; a diameter of the first cylinder being greater than a diameter of the second cylinder; the first cylinder having a passageway to receive a pinch bolt; and
a clip configured to be secured to a frame of the vehicle; the second cylinder configured to be passed through a surface of the clip such that the first cylinder abuts the surface;
wherein each of the extension shaft and the angular portion are configured to be operably coupled to the steering shaft.

2. The device of claim 1 wherein the distance is a vertical distance.

3. The device of claim 1 wherein the angular portion comprises a socket for receiving the steering shaft.

4. The device of claim 1 wherein the extension shaft comprises a notch and a flat portion opposing the notch.

5. The device of claim 3 wherein the extension shaft comprises a notch and a flat portion opposing the notch.

6. The device of claim 5 wherein the notch and the flat portion collectively facilitate the securement of the extension shaft to the steering shaft.

7. The device of claim 6 wherein a height of the straight portion is greater than a height of the opening.

8. The device of claim 7 wherein the clip is secured to the frame via at least one of fasteners and welding.

9. A method for correcting a length and an angle of a steering shaft in a rack and pinion steering system of a vehicle after a vertical distance between a steering wheel and a rack is altered, the method comprising steps:
dividing the steering shaft into a first portion and a second portion;
providing a steering correction device, the device comprising:
a coupler having a straight portion and an angular portion; the straight portion having a proximal end and a distal end; the straight portion being coupled at the proximal end to the angular portion with a universal joint;
an extension shaft; the extension shaft being coupled to the straight portion at the distal end; and
a locking member comprising a threaded shaft and a casing having an opening;
passing the extension shaft through the opening such that the casing is adjacent the straight portion;
coupling the first portion to the angular portion;
coupling the second portion to the extension shaft; and
operably securing the threaded shaft to a frame of the vehicle.

10. The method of claim 9 further comprising steps:
securing a clip to the frame; and
securing a retaining member to the clip;
wherein the retaining member is configured to retain the threaded shaft.

11. The method of claim 10 wherein:
the retaining member comprises a first cylinder and a second cylinder; and
the second cylinder is passed through a surface of the clip prior to the securement of the retaining member to the clip.

12. The method of claim 11 further comprising steps:
passing the threaded shaft through the first cylinder and the second cylinder;
using a pinch bolt to lock the threaded shaft with respect to the retaining member.

13. The method of claim 9 further comprising the step of securing a drop bracket to the frame; wherein the drop bracket comprises a threaded bung configured to retain the threaded shaft.

14. A method for correcting a length and an angle of a steering shaft in a rack and pinion steering system of a vehicle after a vertical distance between a steering wheel and a rack is altered, the steering shaft having a first segment and a second segment, the first segment having a first end and a second end, the second segment having a third end and a fourth end, the first end being operably coupled to the steering wheel, the fourth end being operably coupled to a pinion gear, the second end being coupled to the third end via a first universal joint, the method comprising steps:
decoupling the fourth end from the pinion gear;
providing a steering correction device, the device comprising:
a coupler having a straight portion and an angular portion; the straight portion having a proximal end and a distal end; the straight portion being coupled at the proximal end to the angular portion with a second universal joint;
an extension shaft; the extension shaft being coupled to the straight portion at the distal end; and
a locking member comprising a threaded shaft and a casing having an opening;
passing the extension shaft through the opening such that the casing is adjacent the straight portion;
operably coupling the extension shaft to the fourth end;
operably coupling the angular portion to the pinion gear; and
operably securing the threaded shaft to a frame of the vehicle.

15. The method of claim 14 further comprising steps:
securing a clip to the frame; and
securing a retaining member to the clip;
wherein the retaining member is configured to retain the threaded shaft.

16. The method of claim 15 wherein:
the retaining member comprises a first cylinder and a second cylinder; and
the second cylinder is passed through a surface of the clip prior to the securement of the retaining member to the clip.

17. The method of claim 16 further comprising steps:
passing the threaded shaft through the first cylinder and the second cylinder;
using a pinch bolt to lock the threaded shaft with respect to the retaining member.

18. The method of claim 14 further comprising the step of securing a drop bracket to the frame; wherein the drop bracket comprises a threaded bung configured to retain the threaded shaft.

19. The method of claim 14 wherein the extension shaft comprises a notch and a flat portion opposite the notch.

20. The method of claim 19 wherein:
the first segment makes a first angle with a vertical plane; and
the first angle is not altered.
